(19) United States
(12) Patent Application Publication
(10) Pub. No.: US 2014/0328970 A1
(43) Pub. Date: Nov. 6, 2014

(54) Nutritional Composition Comprising Whey and Hydrolyzed Casein and Uses Thereof

(71) Applicant: Mead Johnson Nutrition Company, (US)

(72) Inventors: John Alvey, Evansville, IN (US); Dattatreya Banavara, Newburgh, IN (US); Brian Berg, Evansville, IN (US); Anja Wittke, Evansville, IN (US); Douglas Burrin, Houston, TX (US)

(21) Appl. No.: 13/886,381

(22) Filed: May 3, 2013

(51) Int. Cl. A23L 1/29

(52) U.S. Cl. CPC A23L 1/296
USPC 426/2; 426/580

(57) ABSTRACT

The present disclosure provides a nutritional composition, such as a preterm infant formula that includes a protein source comprising whey protein and hydrolyzed casein protein. The whey protein to hydrolyzed casein ratio may be from about 90:10 to about 50:50 by weight. The hydrolyzed casein may have a degree of hydrolysis of from about 20% to about 80%. Additionally, provided are methods for improved gastric emptying and improved digestibility in a target subject, such as a preterm infant. When administered, the nutritional compositions may promote intestinal transit and absorptive capacity. Consequently, better growth and development, especially neurological development of the target subject may be achieved.

### TECHNICAL FIELD

The present disclosure relates to nutritional composition comprising a protein source that includes whey and hydrolyzed casein. More specifically, in some embodiments the disclosure relates to nutritional compositions having an intact whey to hydrolyzed casein ratio of from about 90:10 to about 50:50 by weight.

Additionally, the disclosure provides methods for improved gastric emptying and/or digestibility in a subject. Further disclosed are methods for improved intestinal transit and/or intestinal absorption in a subject. In some embodiments the subject is a preterm infant.

### BACKGROUND

The present disclosure relates to a nutritional composition comprising whey and hydrolyzed casein that may be administered to a preterm infant. These nutritional compositions may promote gastric emptying, digestibility, improved intestinal transit and absorption, which may promote growth and development in an infant, especially in a preterm or premature infant. Additionally, the disclosure addresses nutritional deficiencies that may arise in subjects receiving partial or total parenteral nutrition or enteral nutrition.

Nutritional support of the preterm and/or premature infant is of great importance since short-term survival and long-term growth and development are at stake. In particular, preterm infants are a vulnerable population and better nutrient uptake and body growth in the short term can be crucial. For preterm infants, optimizing early postnatal growth is important. Particularly, postnatal head growth is important for the neurodevelopmental outcome in preterm infants.

Approximately one out of eight infants born in the United States are born prematurely. Premature infants have a higher morbidity rate and infants who are born preterm often suffer from long-term neurological disabilities as they age. Preterm mortality is 12% in the United States and is the same in Kenya, Turkey and Honduras. In the United States, the preterm birth rate has risen 30% since 1981. In contrast, most European countries, as well as Canada and Australia, have a preterm infant mortality rate of 7-9%.

Additionally, 30% of infants born weighing less than 1500 g suffer from feeding intolerance and many very-low-birth-weight infants have intermittent gastrointestinal symptoms and complications. While improvements in the field of nutrition have been made via the introduction of parenteral nutrition and milk fortifiers, malnourishment still continues to contribute to morbidity and mortality of preterm infants.

Despite the need for optimal nutrition, during the first few weeks of life a sufficient protein and calorie intake is difficult to achieve in preterm infants due to recommended feeding protocol, tolerance and illness. Guidelines provided by the European Society of Pediatric Gastroenterology, Hepatology and Nutrition points out that an optimal protein intake is crucial for optimal growth and functional development. Accordingly, low protein uptake may contribute to delayed neurodevelopmental outcomes in preterm infants.

Specifically very-low-birth-weight infants have a high protein need but peptic activity is low in early infancy due to the immaturity of the digestive tract. Preterm formulations and preterm human milk fortifier containing whey have traditionally been preferred, in contrast to casein-predominated formulas, due to their better digestibility.

Accordingly, there is a need for safe, yet effective, nutritional compositions that increase protein uptake and gastric emptying in a preterm and/or very-low-birth-weight infant. The present disclosure is directed to a nutritional composition suitable for administration to a preterm infant that comprises a protein source including whey and hydrolyzed casein. More specifically, the protein source may comprise a whey:hydrolyzed casein ratio of about 90:10 to about 50:50 by weight. Without being bound by any particular theory, providing the nutritional composition having whey and hydrolyzed casein in this ratio may promote gastric emptying and digestibility while improving intestinal transit and absorptive capacity.

### BRIEF SUMMARY

Briefly, therefore, the present disclosure is directed to a nutritional composition for addressing nutritional deficiencies in subjects, such as preterm infants, requiring small-volume nutritional support and to methods for promoting healthy development of a subject. The present disclosure provides a preterm nutritional composition comprising a protein source including whey and hydrolyzed casein in a ratio of from about 90:10 to about 50:50 by weight. When administered, the nutritional composition(s) disclosed herein may promote gastric emptying and digestibility while improving intestinal transit and absorptive capacity, thereby preventing the development of nutritional deficiencies or correct existing nutritional deficiencies.

In some embodiments the hydrolyzed casein protein has a degree of hydrolysis of from about 20% to about 80%.

In one embodiment, nutritional composition may further comprise at least one long chain polyunsaturated fatty acid, such as docosahexaenoic acid (“DHA”) and/or arachidonic acid (“ARA”). Additionally, in some embodiments, the nutritional composition may comprise additional vitamins and minerals.

In another embodiment, the present disclosure comprises a method for promoting gastric emptying in a preterm infant, the method comprising administering to the subject a nutritional composition comprising a protein source having a whey:hydrolyzed casein ratio of between 90:10 to 50:50 by weight.

Additionally provided are methods for promoting digestibility in a preterm infant by administering the nutritional composition disclosed herein. Further, provided are methods for improving intestinal transit and protein absorption in a preterm infant by administering the nutritional composition disclosed herein.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

### BRIEF DESCRIPTION OF THE DRAWINGS

FIG. 1 shows the clinical necrotizing enterocolitis incidence in preterm neonatal pigs.

FIG. 2 shows the clinical necrotizing enterocolitis severity score in preterm neonatal pigs.

FIG. 3 illustrates body weight gain in preterm neonatal pigs.

FIG. 4 illustrates weight of the stomach content of preterm neonatal pigs fed hydrolyzed protein versus preterm neonatal pigs fed a composition containing a combination of intact and hydrolyzed protein.

FIG. 5 illustrates the villous height in preterm neonatal pigs fed intact protein versus preterm neonatal pigs fed a nutritional composition including a combination of intact and hydrolyzed protein.

FIG. 6 illustrates the crypt depth in the jejunum and ileum of preterm neonatal pigs fed a combination of hydrolyzed protein and intact versus preterm neonatal pigs fed intact protein.

### DETAILED DESCRIPTION

Reference now will be made in detail to the embodiments of the present disclosure, one or more examples of which are set forth hereinbelow. Each example is provided by way of explanation of the nutritional composition of the present disclosure and is not a limitation. In fact, it will be apparent to those skilled in the art that various modifications and variations can be made to the teachings of the present disclosure without departing from the scope of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present discussion is a description of exemplary embodiments only and is not intended as limiting the broader aspects of the present disclosure.

“Nutritional composition” means a substance or formulation that satisfies at least a portion of a subject's nutrient requirements. The terms “nutritional(s)”, “nutritional formula (s)”, “enteral nutritional(s)”, and “nutritional supplement(s)” are used as non-limiting examples of nutritional composition(s) throughout the present disclosure. Moreover, “nutritional composition(s)” may refer to liquids, powders, gels, pastes, solids, concentrates, suspensions, or ready-to-use forms of enteral formulas, oral formulas, formulas for infants, formulas for pediatric subjects, formulas for children, growing-up milks and/or formulas for adults.

The term “enteral” means deliverable through or within the gastrointestinal, or digestive, tract. “Enteral administration” includes oral feeding, intragastric feeding, transpyloric administration, or any other administration into the digestive tract. “Administration” is broader than “enteral administration” and includes parenteral administration or any other route of administration by which a substance is taken into a subject's body.

The term “degree of hydrolysis” refers to the extent to which peptide bonds are broken by a hydrolysis method. For example, where the hydrolyzed protein has a degree of hydrolysis of 40%, this means that at least 40% of the peptide bonds have been broken by a hydrolysis method.

The term “partially hydrolyzed” means having a degree of hydrolysis which is greater than 0% but less than 50%.

The term “extensively hydrolyzed” means having a degree of hydrolysis which is greater than or equal to 50%.

As used herein the terms “whey” and/or “intact whey” mean whey protein that has not been subjected to hydrolysis processing.

“Pediatric subject” means a human less than 13 years of age. In some embodiments, a pediatric subject refers to a human subject that is between birth and 8 years old. In other embodiments, a pediatric subject refers to a human subject between 1 and 6 years of age. In still further embodiments, a pediatric subject refers to a human subject between 6 and 12 years of age. The term “pediatric subject” may refer to infants (preterm or full term) and/or children, as described below.

“Child” means a subject ranging in age from 12 months to about 13 years. In some embodiments, a child is a subject between the ages of 1 and 12 years old. In other embodiments, the terms “children” or “child” refer to subjects that are between one and about six years old, or between about seven and about 12 years old. In other embodiments, the terms “children” or “child” refer to any range of ages between 12 months and about 13 years.

“Infant” means a human subject ranging in age from birth to not more than one year and includes infants from 0 to 12 months corrected age. The phrase “corrected age” means an infant's chronological age minus the amount of time that the infant was born premature. Therefore, the corrected age is the age of the infant if it had been carried to full term. The term infant includes low birth weight infants, very low birth weight infants, and preterm infants.

“Preterm infant” means a subject born before 37 weeks gestational age. The phrase “preterm infant” is used interchangeably with the phrase “premature infant.”

“Low birth weight infant” means an infant born weighing less than 2500 grams (approximately 5 lbs, 8 ounces).

“Very low birth weight infant” means an infant born weighing less than 1500 grams (approximately 3 lbs, 4 ounces).

“Children's nutritional product” refers to a composition that satisfies at least a portion of the nutrient requirements of a child. A growing-up milk is an example of a children's nutritional product.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

“Nutritionally complete” means a composition that may be used as the sole source of nutrition, which would supply essentially all of the required daily amounts of vitamins, minerals, and/or trace elements in combination with proteins, carbohydrates, and lipids. Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject.

Therefore, a nutritional composition that is “nutritionally complete” for a preterm infant will, by definition, provide qualitatively and quantitatively adequate amounts of carbohydrates, lipids, essential fatty acids, proteins, essential amino acids, conditionally essential amino acids, vitamins, minerals, and energy required for growth of the preterm infant.

A nutritional composition that is “nutritionally complete” for a full term infant will, by definition, provide qualitatively and quantitatively adequate amounts of all carbohydrates, lipids, essential fatty acids, proteins, essential amino acids, conditionally essential amino acids, vitamins, minerals, and energy required for growth of the full term infant.

A nutritional composition that is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child.

All percentages, parts and ratios as used herein are by weight of the total formulation, unless otherwise specified.

The nutritional formulation of the present disclosure may also be substantially free of any optional or selected ingredients described herein, provided that the remaining nutritional formulation still contains all of the required ingredients or features described herein. In this context, and unless otherwise specified, the term “substantially free” means that the selected formulation contains less than a functional amount of the optional ingredient, typically less than 0.1% by weight, and also, including zero percent by weight of such optional or selected ingredient.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present invention, including components thereof, can comprise, consist of, or consist essentially of the essential elements and limitations of the invention described herein, as well as any additional or optional ingredients, components or limitations described herein or otherwise useful in nutritional formulations.

As used herein, the term “about” should be construed to refer to both of the numbers specified in any range. Any reference to a range should be considered as providing support for any subset within that range.

The nutritional formulation of the present disclosure may provide nutritional support and personalized nutrition to preterm infants, to infants or to any other patient with unmet nutritional needs. Thus, in some embodiments, the nutritional composition is designed to meet specific nutritional needs of individual subjects, such as infants or preterm infants, in stable, unit-dose liquid formulations standardized to a caloric content and/or as a concentrate to meet a subject's particular nutritional needs.

The present disclosure provides a nutritional composition comprising a protein source that includes intact whey and casein hydrolysate. The protein source may comprise from about 90% to about 50% w/w intact whey and from about 10% to about 50% w/w hydrolyzed casein. Without being bound by any particular theory, it is believed that this ratio of intact whey and hydrolyzed casein is better absorbed upon administration than nutritional compositions comprising only intact protein. Furthermore, it is believed that a nutritional composition comprising both hydrolyzed casein and whey provides superior nutrition than nutritional compositions comprising only whey protein. Additionally, this ratio of intact whey and hydrolyzed casein may further facilitate gastric emptying and intestinal transit as compared to nutritional compositions comprising only intact protein.

In some embodiments the nutritional composition may comprise a protein source including a whey:hydrolyzed casein ratio of from about 80:20 to about 50:50 by weight. In still some embodiments the protein source may comprise a whey:hydrolyzed casein ratio of from about 70:30 to about 50:50. In still some embodiments, the protein source may comprise whey:hydrolyzed casein from about 60:40 w/w to about 50:50 w/w.

In some embodiments, the nutritional composition may comprise an effective amount of a combination of intact whey and hydrolyzed casein. As used in this embodiment, effective amount means an amount sufficient to provide health benefits when administered to a subject. More specifically and without being limiting, effective amount includes an amount sufficient to promote gastric emptying, facilitate intestinal transit, and/or improve nutrient uptake in a subject as compared to combinations of intact whey and intact casein. In some embodiments, the subject may be a preterm infant. In still other embodiments, the subject may be a low-birth-weight infant or a very-low-birth-weight infant.

In some embodiments, the nutritional composition may comprise a protein source having an effective ratio of intact whey and hydrolyzed casein. As used in this embodiment, an effective ratio means an amount sufficient to provide health benefits when administered to a subject. In some embodiments the effective ratio of intact whey to hydrolyzed casein may be from about 90:10 w/w to about 50:50 w/w. In certain embodiments, the effective ratio of intact whey to hydrolyzed casein includes a ratio sufficient to promote gastric emptying, facilitate intestinal transit, increase villous height in the gastrointestinal tract, and/or improve nutrient uptake in a subject. The subject may, in some embodiments, include a preterm infant, a low-birth-weight infant, and/or a very-low-birth-weight-infant.

As used herein, in some embodiments, the hydrolyzed casein may have a degree of hydrolysis of from about 20% to about 80%. In some embodiments the hydrolyzed casein has a degree of hydrolysis of from about 30% to about 70%. Still in some embodiments, the hydrolyzed casein may have a degree of hydrolysis of from about 40% to about 50%. Without being bound by any particular theory, it is believed that providing casein having the degree of hydrolysis disclosed herein may improve gastric emptying and intestinal transit as compared to proteins having a lower degree of hydrolysis. Further providing the hydrolyzed casein having the degree of hydrolysis as described herein may prevent the incidence of casein clots in the stomach and/or intestines of the target subject, i.e. a preterm infant.

In some embodiments, the protein source including both intact protein and hydrolyzed casein is present in the nutritional composition in an amount from about 1 g/100 kcal to about 10 g/100 kcal. In still other embodiments, the protein source is present in an amount from about 2.2 g/100 kcals to about 8.0 g/100 kcals. Still, in some embodiments, the protein source is present in the nutritional composition in an amount from about 4 g/100 kcals to about 6 g/100 kcals.

The protein source of the present disclosure may comprise only intact whey and hydrolyzed casein. In some embodiments, the hydrolyzed casein may be extensively hydrolyzed, while in other embodiments the hydrolyzed casein may be partially hydrolyzed. The protein source may, in some embodiments, include other proteins and/or protein equivalent sources in addition to intact whey and hydrolyzed casein. For example, the protein source may include additional amino acids, including essential and/or non-essential amino acids. In some embodiments, the amino acids may comprise, but are not limited to, histidine, isoleucine, leucine, lysine, methionine, cysteine, phenylalanine, tyrosine, threonine, tryptophan, valine, alanine, arginine, asparagine, aspartic acid, glutamic acid, glutamine, glycine, proline, serine, carnitine, taurine and mixtures thereof. In some embodiments, the amino acids may be branched chain amino acids. In certain other embodiments, small amino acid peptides may be included as the protein component of the nutritional composition. Such small amino acid peptides may be naturally occurring or synthesized.

The protein source of the nutritional composition can be any used in the art, e.g., nonfat milk, whey protein, casein, soy protein, hydrolyzed protein, amino acids, and the like. Bovine milk protein sources useful in practicing the present disclosure include, but are not limited to, milk protein powders, milk protein concentrates, milk protein isolates, nonfat milk solids, nonfat milk, nonfat dry milk, whey protein, whey protein isolates, whey protein concentrates, sweet whey, acid whey, casein, acid casein, caseinate (e.g. sodium caseinate, sodium calcium caseinate, calcium caseinate) and any combinations thereof.

In some embodiments, the nutritional composition comprises at least one carbohydrate source. The carbohydrate source can be any used in the art, e.g., lactose, glucose, fructose, corn syrup solids, maltodextrins, sucrose, starch, rice syrup solids, and the like. The amount of the carbohydrate component in the nutritional composition typically can vary from between about 5 g/100 kcal and about 25 g/100 kcal. In some embodiments, the amount of carbohydrate is between about 6 g/100 kcal and about 22 g/100 kcal. In other embodiments, the amount of carbohydrate is between about 12 g/100 kcal and about 14 g/100 kcal. In some embodiments, corn syrup solids are preferred. Moreover, hydrolyzed, partially hydrolyzed, and/or extensively hydrolyzed carbohydrates may be desirable for inclusion in the nutritional composition due to their easy digestibility. Specifically, hydrolyzed carbohydrates are less likely to contain allergenic epitopes.

Non-limiting examples of carbohydrate materials suitable for use herein include hydrolyzed or intact, naturally or chemically modified, starches sourced from corn, tapioca, rice or potato, in waxy or non-waxy forms. Non-limiting examples of suitable carbohydrates include various hydrolyzed starches characterized as hydrolyzed cornstarch, maltodextrin, maltose, corn syrup, dextrose, corn syrup solids, glucose, and various other glucose polymers and combinations thereof. Non-limiting examples of other suitable carbohydrates include those often referred to as sucrose, lactose, fructose, high fructose corn syrup, indigestible oligosaccharides such as fructooligosaccharides and combinations thereof.

The nutritional composition may also comprise a fat source. Suitable fat or lipid sources for the nutritional composition of the present disclosure may be any known or used in the art, including but not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palm olein oil, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

In some embodiments, the fat source may be present in the nutritional composition in an amount from about 1 g/100 kcals to about 11 g/100 kcals. In still some embodiments, the fat source may be present in an amount form about 2 g/100 kcals to about 10 g/100 kcals.

In some embodiments, the nutritional composition may comprise choline. When provided, choline may be present in the nutritional composition in an amount from about 5 mg/100 kcals to about 75 mg/100 kcals. Still in some embodiments, choline may be present in an amount from about 10 mg/100 kcals to about 50 mg/100 kcals.

In some embodiments the nutritional composition may also include a source of long chain polyunsaturated fatty acid (“LCPUFA”). In one embodiment the amount of LCPUFA in the nutritional composition is at least about 5 mg/100 kcal, and may vary from about 5 mg/100 kcal to about 100 mg/100 kcal, more preferably from about 10 mg/100 kcal to about 50 mg/100 kcal. Non-limiting examples of LCPUFAs include, but are not limited to, docosahexaenoic acid (“DHA”), arachidonic acid (“ARA”), linoleic (18:2 n-6), α-linolenic (18:3 n-6), dihomo-α-linolenic (20:3 n-6) acids in the n-6 pathway, α-linolenic (18:3 n-3), stearidonic (18:4 n-3), eicosatetraenoic (20:4 n-3), eicosapentaenoic (20:5 n-3), and docosapentaenoic (22:6 n-3).

In some embodiments, the LCPUFA included in the nutritional composition may comprise DHA. In one embodiment the amount of DHA in the nutritional composition is advantageously at least about 17 mg/100 kcal, and may vary from about 5 mg/100 kcal to about 75 mg/100 kcal, more preferably from about 10 mg/100 kcal to about 50 mg/100 kcal.

In another embodiment, especially if the nutritional composition is an infant formula, the nutritional composition is supplemented with both DHA and ARA. In this embodiment, the weight ratio of ARA:DHA may be between about 1:3 and about 9:1. In a particular embodiment, the ratio of ARA:DHA is from about 1:2 to about 4:1.

The DHA and ARA can be in natural form, provided that the remainder of the LCPUFA source does not result in any substantial deleterious effect on the target subject. Alternatively, the DHA and ARA can be used in refined form.

The disclosed nutritional composition(s) may be provided in any form known in the art, such as a powder, a gel, a suspension, a paste, a solid, a liquid, a liquid concentrate, a reconstituteable powdered milk substitute or a ready-to-use product. The nutritional composition may, in certain embodiments, comprise a nutritional supplement, children's nutritional product, infant formula, preterm infant formula, enteral infant formula, human milk fortifier, growing-up milk or any other nutritional composition designed for an infant, including a preterm infant, or a pediatric subject. Nutritional compositions of the present disclosure include, for example, orally-ingestible, health-promoting substances including, for example, foods, beverages, tablets, capsules and powders. Moreover, the nutritional composition of the present disclosure may be standardized to a specific caloric content, it may be provided as a ready-to-use product, or it may be provided in a concentrated form. In some embodiments, the nutritional composition is in powder form with a particle size in the range of 5 μm to 1500 μm, more preferably in the range of 10 μm to 300 μm.

The nutritional compositions disclosed herein may be suitable for enteral or parenteral administration. This includes delivery to a target subject via nasogastric tube, intragastric feeding, transpyloric administration and/or any other means of administration that result in the introduction of the nutritional formulation into the digestive tract of a target subject.

If the nutritional composition is in the form of a ready-to-use product, the osmolality of the nutritional composition may be between about 100 and about 1100 mOsm/kg water, more typically about 200 to about 700 mOsm/kg water.

In certain embodiments, the nutritional composition may be hypoallergenic. In other embodiments, the nutritional composition is kosher and/or halal. In still further embodiments, the nutritional composition contains non-genetically modified ingredients. In an embodiment, the nutritional formulation is sucrose-free. The nutritional composition may also be lactose-free. In other embodiments, the nutritional composition does not contain any medium-chain triglyceride oil. In some embodiments, no carrageenan is present in the composition. In other embodiments, the nutritional composition is free of all gums.

The nutritional composition of the present disclosure is not limited to compositions comprising nutrients specifically listed herein. Any nutrients may be delivered as part of the composition for the purpose of meeting nutritional needs and/or in order to optimize the nutritional status in a subject.

Moreover, in some embodiments, the nutritional composition is nutritionally complete, containing suitable types and amounts of lipids, carbohydrates, proteins, vitamins and minerals to be a subject's sole source of nutrition. Indeed, the nutritional composition may optionally include any number of proteins, peptides, amino acids, fatty acids, probiotics and/or their metabolic by-products, prebiotics, carbohydrates and any other nutrient or other compound that may provide many nutritional and physiological benefits to a subject. Further, the nutritional composition of the present disclosure may comprise flavors, flavor enhancers, sweeteners, pigments, vitamins, minerals, therapeutic ingredients, functional food ingredients, food ingredients, processing ingredients or combinations thereof.

The nutritional composition of the present disclosure may be standardized to a specific caloric content, it may be provided as a ready-to-use product, or it may be provided in a concentrated form.

The exact composition of a nutritional composition according to the present disclosure can vary from market-to-market, depending on local regulations and dietary intake information of the population of interest. In some embodiments, nutritional compositions according to the disclosure consist of a milk protein source, such as whole or skim milk, plus added sugar and sweeteners to achieve desired sensory properties, and added vitamins and minerals. The fat composition is typically derived from the milk raw materials. Total protein can be targeted to match that of human milk, cow milk or a lower value. Total carbohydrate is usually targeted to provide as little added sugar, such as sucrose or fructose, as possible to achieve an acceptable taste. Typically, Vitamin A, calcium and Vitamin D are added at levels to match the nutrient contribution of regional cow milk. Otherwise, in some embodiments, vitamins and minerals can be added at levels that provide approximately 20% of the dietary reference intake (DRI) or 20% of the Daily Value (DV) per serving. Moreover, nutrient values can vary between markets depending on the identified nutritional needs of the intended population, raw material contributions and regional regulations.

The disclosed nutritional composition described herein, can, in some embodiments also comprise a source of iron. The iron may comprise encapsulated iron forms, such as encapsulated ferrous fumarate or encapsulated ferrous sulfate or less reactive iron forms, such as ferric pyrophosphate or ferric orthophosphate.

One or more vitamins and/or minerals may also be added in to the nutritional composition in amounts sufficient to supply the daily nutritional requirements of a subject. It is to be understood by one of ordinary skill in the art that vitamin and mineral requirements will vary, for example, based on the age of the child. For instance, an infant may have different vitamin and mineral requirements than a preterm infant. Similarly, an infant may have different vitamin and mineral requirements than a child between the ages of one and thirteen years. Thus, the embodiments are not intended to limit the nutritional composition to a particular age group but, rather, to provide a range of acceptable vitamin and mineral components.

In embodiments providing a nutritional composition for a preterm infant, the composition may optionally include, but is not limited to, one or more of the following vitamins or derivations thereof: vitamin B₁ (thiamin, thiamin pyrophosphate, TPP, thiamin triphosphate, TTP, thiamin hydrochloride, thiamin mononitrate), vitamin B₂ (riboflavin, flavin mononucleotide, FMN, flavin adenine dinucleotide, FAD, lactoflavin, ovoflavin), vitamin B₃ (niacin, nicotinic acid, nicotinamide, niacinamide, nicotinamide adenine dinucleotide, NAD, nicotinic acid mononucleotide, NicMN, pyridine-3-carboxylic acid), vitamin B₃-precursor tryptophan, vitamin B₆ (pyridoxine, pyridoxal, pyridoxamine, pyridoxine hydrochloride), pantothenic acid (pantothenate, panthenol), folate (folic acid, folacin, pteroylglutamic acid), vitamin B₁₂ (cobalamin, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D3, 1,25,-dihydroxyvitamin D), vitamin E (α-tocopherol, α-tocopherol acetate, α-tocopherol succinate, α-tocopherol nicotinate, α-tocopherol), vitamin K (vitamin K₁, phylloquinone, naphthoquinone, vitamin K₂, menaquinone-7, vitamin K₃, menaquinone-4, menadione, menaquinone-8, menaquinone-8H, menaquinone-9, menaquinone-9H, menaquinone-10, menaquinone-11, menaquinone-12, menaquinone-13), choline, inositol, β-carotene and any combinations thereof.

In embodiments providing a nutritional composition, such as a preterm infant formula, the composition may optionally include, but is not limited to, one or more of the following minerals or derivations thereof: boron, calcium, calcium acetate, calcium gluconate, calcium chloride, calcium lactate, calcium phosphate, calcium sulfate, chloride, chromium, chromium chloride, chromium picolonate, copper, copper sulfate, copper gluconate, cupric sulfate, fluoride, iron, carbonyl iron, ferric iron, ferrous fumarate, ferric orthophosphate, iron trituration, polysaccharide iron, iodide, iodine, magnesium, magnesium carbonate, magnesium hydroxide, magnesium oxide, magnesium stearate, magnesium sulfate, manganese, molybdenum, phosphorus, potassium, potassium phosphate, potassium iodide, potassium chloride, potassium acetate, selenium, sulfur, sodium, docusate sodium, sodium chloride, sodium selenate, sodium molybdate, zinc, zinc oxide, zinc sulfate and mixtures thereof. Non-limiting exemplary derivatives of mineral compounds include salts, alkaline salts, esters and chelates of any mineral compound.

The minerals can be added to nutritional compositions, such as preterm infant formulas, in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals can be added as known within the art.

In an embodiment, the nutritional composition may contain between about 10 and about 50% of the maximum dietary recommendation for any given country, or between about 10 and about 50% of the average dietary recommendation for a group of countries, per serving, of vitamins A, C, and E, zinc, iron, iodine, selenium, and choline. In another embodiment, the nutritional composition may supply about 10-30% of the maximum dietary recommendation for any given country, or about 10-30% of the average dietary recommendation for a group of countries, per serving of B-vitamins. In yet another embodiment, the levels of vitamin D, calcium, magnesium, phosphorus, and potassium in the nutritional composition may correspond with the average levels found in milk. In other embodiments, other nutrients in the nutritional composition may be present at about 20% of the maximum dietary recommendation for any given country, or about 20% of the average dietary recommendation for a group of countries, per serving.

The nutritional composition(s) of the present disclosure may optionally include one or more of the following flavoring agents, including, but not limited to, flavored extracts, volatile oils, cocoa or chocolate flavorings, peanut butter flavoring, cookie crumbs, vanilla or any commercially available flavoring. Examples of useful flavorings include, but are not limited to, pure anise extract, imitation banana extract, imitation cherry extract, chocolate extract, pure lemon extract, pure orange extract, pure peppermint extract, honey, imitation pineapple extract, imitation rum extract, imitation strawberry extract, grape and or grape seed extracts, apple extract, bilberry extract or vanilla extract; or volatile oils, such as balm oil, bay oil, bergamot oil, cedarwood oil, cherry oil, cinnamon oil, clove oil, or peppermint oil; peanut butter, chocolate flavoring, vanilla cookie crumb, butterscotch, toffee, and mixtures thereof. The amounts of flavoring agent can vary greatly depending upon the flavoring agent used. The type and amount of flavoring agent can be selected as is known in the art.

The nutritional compositions of the present disclosure may optionally include one or more emulsifiers that may be added for stability of the final product. Examples of suitable emulsifiers include, but are not limited to, lecithin (e.g., from egg or soy or any other plant and animal sources), alpha lactalbumin and/or mono- and di-glycerides, and mixtures thereof. Other emulsifiers are readily apparent to the skilled artisan and selection of suitable emulsifier(s) will depend, in part, upon the formulation and final product.

The nutritional compositions of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The nutritional compositions of the present disclosure may optionally include one or more stabilizers. Suitable stabilizers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, CITREM (citric acid esters of mono- and diglycerides), and mixtures thereof.

The present disclosure further provides a method for promoting gastric emptying in a target subject. The method comprises providing and/or administering the nutritional composition described herein to a target subject. In some embodiments, the method for promoting gastric emptying in a target subject includes providing a nutritional composition that includes a protein source comprising an effective ratio of intact whey and hydrolyzed casein to a target subject. In some embodiments, the target subject is a preterm infant. In some other embodiments, the target subject may be a low-birth-weight infant. In still some embodiments, the target subject may be a very-low-birth-weight infant.

Without being bound by any particular theory, the nutritional composition of the present disclosure having intact whey and hydrolyzed casein may prevent the incidence of clots, especially casein clots, and curds from forming in the stomach and intestines, thereby facilitating gastric emptying.

Often times, in preterm infants the protein and calorie intake and subsequent absorption of these nutrients from the intestine is often lower than assumed intakes. As such, despite the fact that infant formulas and/or other nutritional supplements are formulated to provide a certain amount of calories and other nutrients, often these nutrients are not fully absorbed by preterm infants. Additionally, ingredients used in these nutritional compositions, such as intact casein and/or intact whey, may adversely affect the absorptive capability of the gastrointestinal tract of the preterm infant.

Additionally, when providing and/or administering a nutritional composition to a preterm infant, there are several competing factors that must be considered. For example, while gastric emptying and intestinal transit are desirable to prevent the formation of clots in the stomach and intestines, the gastrointestinal transit must not be so fast as to prevent effective uptake of nutrients from the formula.

Accordingly, the present method described herein, includes providing and/or administering a nutritional composition comprising a protein source including whey and hydrolyzed casein in a ratio of about 90:10 w/w to about 50:50 w/w to a preterm infant. Additionally, the method includes administering a nutritional composition to a preterm infant, wherein the nutritional composition comprises a protein source including an effective ratio of whey and hydrolyzed casein.

Without being bound by any particular theory, the nutritional composition of the present disclosure, including the whey:hydrolyzed casein ratio described herein is unique in that it both promotes intestinal transit and gastric emptying, which prevents and/or reduces the formation of clots and curds, and simultaneously promotes the digestion and uptake of nutrients from the nutritional composition. In addition the whey:hydrolyzed casein ratio provide herein may prevent and/or reduce the formation of casein clots and curds thus facilitating respiration in a preterm infant.

Additionally, in some embodiments the hydrolyzed casein included in the nutritional composition provided to the target subject may have a degree of hydrolysis of from about 20% to about 80%. Without being bound by any particular theory, it is believed that utilizing a hydrolyzed casein having a degree of hydrolysis as described herein may further facilitate gastric emptying and promote intestinal transit and absorption as compared to nutritional compositions comprising intact casein or hydrolyzed casein having a different degree of hydrolysis than as described herein.

Additionally disclosed herein is a method for promoting head growth and improving the neurological outcome in a preterm infant. The method comprises administering to a preterm infant a nutritional composition comprising a carbohydrate source, a fat source, and a protein source, wherein the protein source comprises a whey:hydrolyzed casein ratio of from about 90:10 to about 50:50 by weight. In some embodiments the hydrolyzed casein may have a degree of hydrolysis of about 20% to about 80%. Still, in some embodiments, the preterm infant may be a low-birth-weight infant or a very-low-birth-weight infant.

### EXAMPLES

Examples are provided to illustrate gastric motility and protein absorption of the whey/casein protein source of the present disclosure. Briefly, the uptake of intact whey, hydrolyzed whey, intact casein and hydrolyzed casein was observed in the preterm neonatal pig. These examples should not be interpreted as any limitation on the nutritional compositions disclosed herein, but serve as illustrations of intestinal transit, gastric emptying and gastric uptake of the whey:casein protein source described herein. It is intended that the specification, together with the example, be considered to be exemplary only, with the scope and spirit of the disclosure being indicated by the claims which follow the examples.

### Example 1

For this example, neonatal pigs were delivered by C-section twelve days preterm. Upon delivery the neonatal pigs underwent a surgical procedure to insert an orgastric tub and have a jugular venous cathedar placed. After these procedures, the neonatal pigs were then divided into two groups, the early abrupt group and the late abrupt group. The early abrupt group was fed total parenteral nutrition at a rate of approximately 10 mL/kg*hr for the first 2 days of life. The late abrupt group was fed total parenteral nutrition at a rate of approximately 10 mL/kg*hr for the first 5 days of life.

On day three of life, the early abrupt group was placed on a feeding program receiving half of their daily nutrition from an enteral source and the other half of their nutrition from a parenteral source. The early abrupt pigs were administered enteral formula at 30 mL/kg every 3 hours plus parenteral feeding at 10 mL/kg*hr. Of the early abrupt group, roughly half of the piglets were fed an enteral formula having intact protein and the other half were fed an enteral formula containing hydrolyzed casein.

Similarly, on day six of life, the late abrupt group was placed on a feeding program where they received half of their daily nutrition from an enteral source and the other half of their nutrition from a parenteral source. The late abrupt neonatal pigs were administered enteral formula at 30 mL/kg every 3 hours plus parenteral feeding at 10 mL/kg*hr, which is the same administration as the early abrupt pigs, only the enteral feed was introduced on day six of life. Approximately half of the late abrupt piglets were fed an enteral formula having intact protein and the other half were fed an enteral formula having hydrolyzed casein.

The composition of both the intact protein enteral formula and hydrolyzed casein enteral formula is shown in Table 1 below. All concentrations listed in Table 1 are in grams/Liter (g/L).

TABLE 1

| | Intact Protein | Hydrolyzed Casein |
|---|---|---|
| | Enteral Formula | Enteral formula |
| Milk Protein Isolate | 34.1 | 0.0 |
| Casein Hydrolysate | 0.0 | 28.7 |
| Whey Protein Isolate | 31.4 | 37.7 |
| Total Protein | 65.5 | 66.4 |
| Medium-Chain Triglyceride Oil | 24.7 | 24.7 |
| Soybean oil | 18.2 | 18.2 |
| High Oleic Sunflower Oil | 16.1 | 16.1 |
| Total Fat | 59.0 | 59.0 |
| Corn Syrup Solids | 59.2 | 60.1 |
| Total Carbohydrate | 59.2 | 60.1 |

The neonatal pigs were monitored for signs of necrotizing enterocolitis at each feeding. Additionally, the neonatal pigs were euthanized at signs of necrotizing enterocolitis or 5 days after the start of enteral feed and tissue samples were collected upon death. The stomach contents of each pig were weighed at the time of death. To determine the severity and incidence of necrotizing enterocolitis a clinical NEC score ranging from 1-6 was assigned. Macroscopic evidence of inflammation, edema, hemorrhage, necrosis, and pneumatosis as observed in the stomach, jejunum, ileum, and colon was also collected. For the purposes of this study, A positive NEC score was considered to be a score greater than or equal to 3 in any gastrointestinal segment.

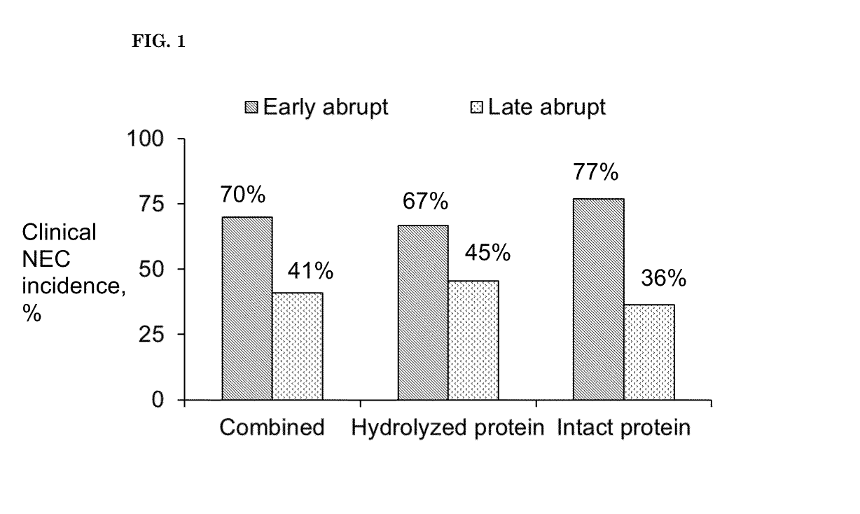

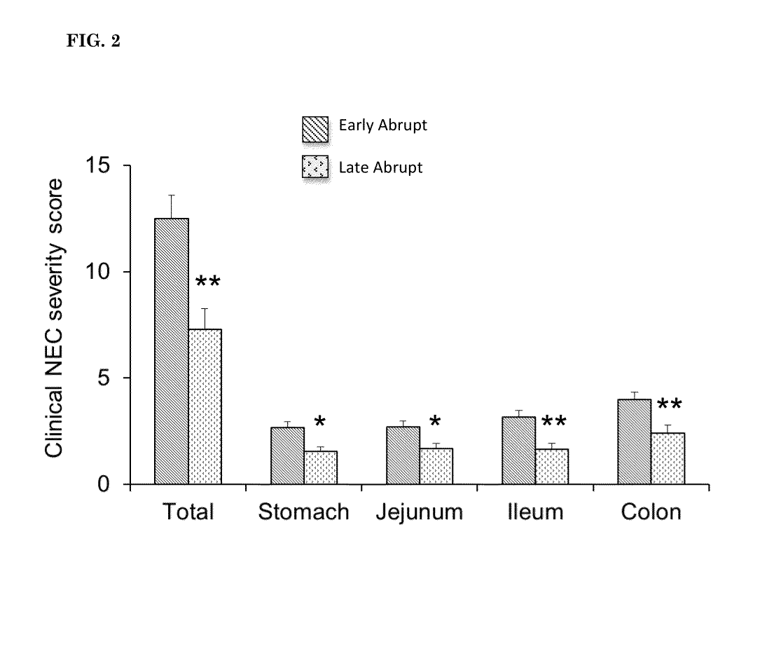

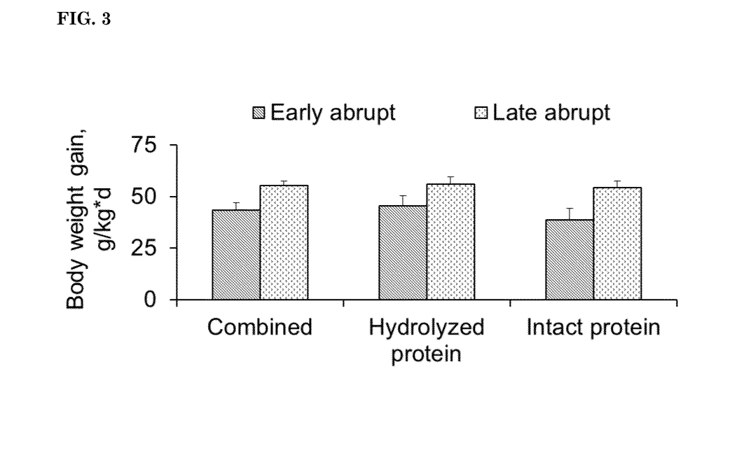

As can be seen in FIG. 1 the clinical incidence scores were lower in the later abrupt group than in the early abrupt group. Additionally, the NEC severity score was lower in the late abrupt group as compared to the early abrupt group for all GI segments scored. See. FIG. 2. The late abrupt group also experienced higher body weight gain that the early abrupt group. See. FIG. 3.

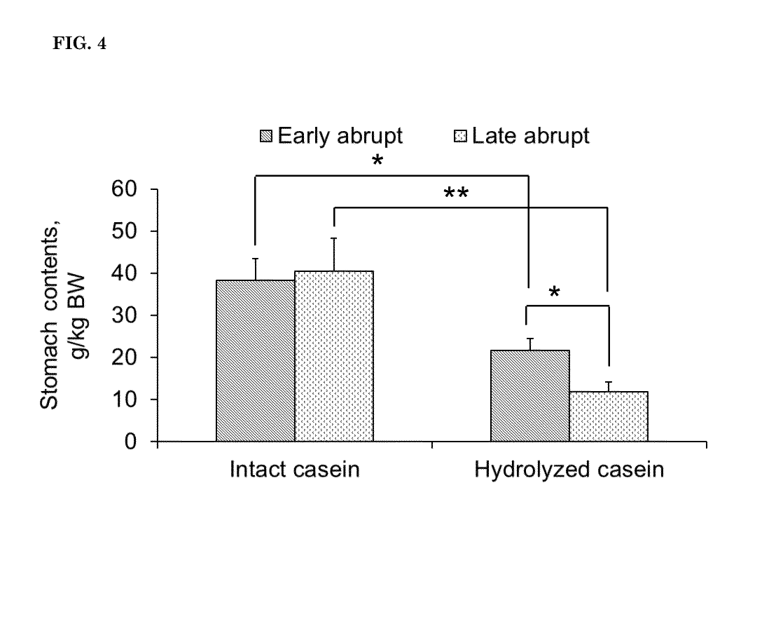

The stomach contents were heavier in enterally-fed pigs with intact protein versus hydrolyzed protein. As can be seen in FIG. 4, both the early abrupt group and late abrupt group that were fed intact protein experienced higher stomach content weight as compared to the groups that were fed hydrolyzed protein. Accordingly, preterm piglets that were fed an intact protein formula had heavier stomach contents as compared to preterm piglets fed a formula comprising a combination of whey and hydrolyzed protein, 37.9 g versus 22.70 grams respectively.

Given the weight of stomach contents in preterm neonatal piglets, the nutritional composition of the present disclosure, which includes both intact whey protein and hydrolyzed casein in a w/w ratio of about 90:10 to about 50:50 may facilitate gastric emptying when administered to a subject, such as a preterm infant.

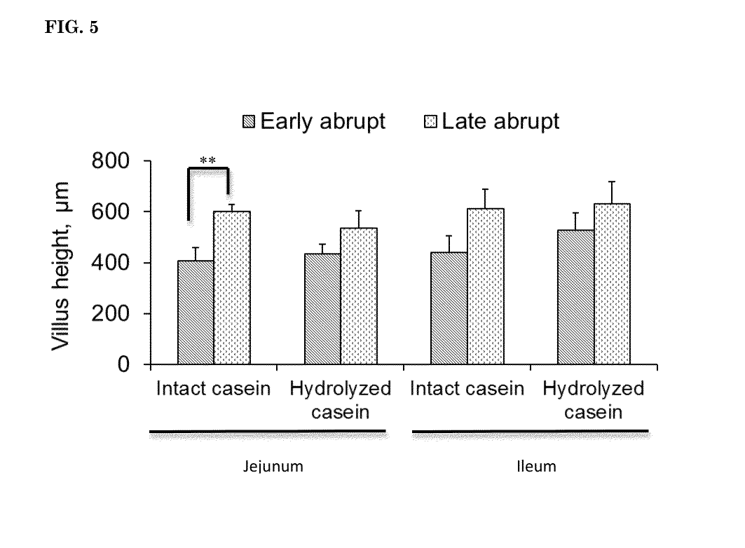

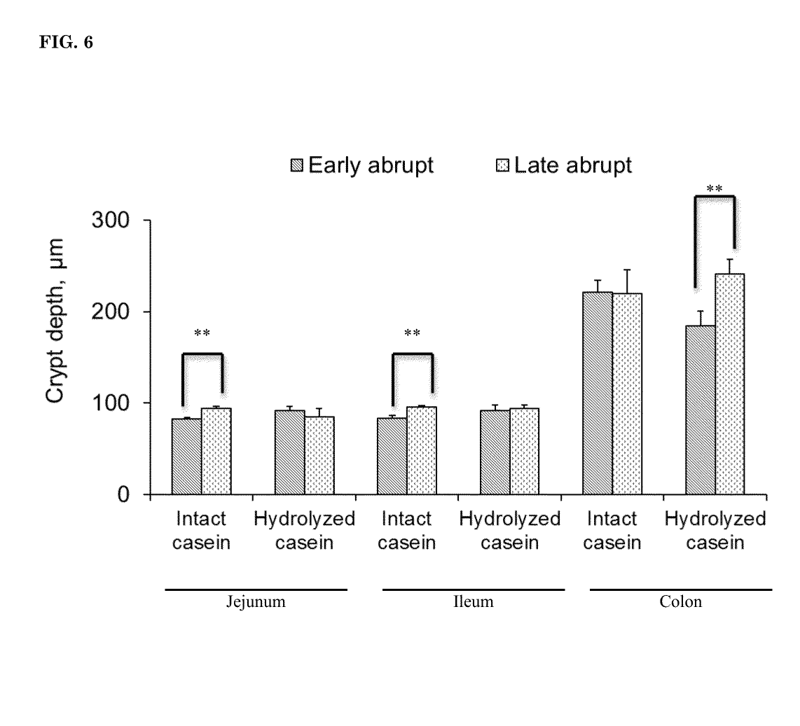

Additionally, as can be seen in FIG. 5 the villous height in the jejunum of the preterm piglets was higher in the late-abrupt group fed intact protein. Moreover, the crypt depth was higher in the late-abrupt group fed intact protein in the jejunum and ileum of the preterm piglets, whereas crypt depth was higher in the colon of preterm piglets fed a formula containing a combination of whey and hydrolyzed casein. See. FIG. 6. Accordingly, a certain amount of intact protein may facilitate protein uptake and digestibility in the preterm piglet.

Preterm neonatal piglets fed intact casein experienced a lower villous height in the distal ileum than in preterm neonatal piglets fed the hydrolyzed casein formula. The villous height was 458.5+/−52.5 μm for the intact protein group versus 648.7+/−72.5 μm for the hydrolyzed casein group. As such, the nutritional composition comprising an effective ratio of intact whey and hydrolyzed casein may facilitate maintaining villous height and/or improve villous height in the distal ileum of preterm infants as compared to nutritional compositions comprising only intact protein. As such, administering the nutritional composition described herein may promote nutrient absorption and digestibility.

The preterm pigs in the early abrupt group had a higher incidence and severity of NEC scores, both clinical and histological, as compared to the late-abrupt group. Additionally, pigs fed an intact protein formula had greater stomach content weight than pigs fed a formula containing a combination of intact and hydrolyzed protein, specifically intact whey and hydrolyzed casein. This suggests that the nutritional composition comprising intact whey and hydrolyzed casein accelerated intestinal transit in preterm piglets. Additionally, these results suggest that a nutritional formula including hydrolyzed protein improved intestinal transit without increasing the risk of necrotizing enterocolitis in preterm piglets.

### Formulation Examples

Table 2 provides an example embodiment of a preterm infant formula including intact whey and hydrolyzed casein as described herein. This example provides the amount of each ingredient to be included per 100 kcal of nutritional composition.

TABLE 2
Nutrition profile of an example preterm infant formula

| Nutrient | per 100 kcal |
|---|---|
| Corn Syrup Solids (g) | 6.38 |
| Whey Protein Concentrate (g) | 3.41 |
| Lactose (g) | 2.896 |
| Medium-Chain triglyceride oil (g) | 2.04 |
| Soy Oil FCC K (g) | 1.53 |
| Sunflower oil - High oleic K (g) | 1.0836 |
| Casein Hydrolysate (g) | 0.8 |
| Calcium Phosphate, Tribasic (mg) | 427.09 |
| Lecithin Concentrate (mg) | 153 |
| Calcium Carbonate (mg) | 127.9 |
| Dry Vitamin Premix (mg) | 124.4 |
| Potassium Chloride (mg) | 97.3 |
| Sodium Citrate Dihydrate (mg) | 66.3 |
| Magnesium Phosphate (mg) | 61.24 |
| Sodium Ascorbate (mg) | 58.44 |
| Mono- and Di-glycerides (mg) | 50.0 |
| Sodium Chloride (mg) | 45.1 |
| Carrageenan (mg) | 38.43 |
| Choline Chloride (mg) | 27.6 |
| Nucleotide premix (mg) | 12.1 |
| Ferrous sulfate (mg) | 10 |
| A, D, E, K1 (mg) | 9.8 |
| Zinc Sulfate monohydrate FCC (mg) | 4.3 |
| L-Carnitine K (mg) | 2.9 |
| Cupric Sulfate PWD (mg) | 0.4 |

Table 3 provides an example embodiment of a preterm infant formula including intact whey and hydrolyzed casein as described herein. This example provides the amount of each ingredient to be included per 100 kcal of nutritional composition.

TABLE 3
Nutrition profile of an example preterm infant formula

| Nutrient | per 100 kcal |
|---|---|
| Corn Syrup Solids (g) | 7.1 |
| Whey Protein Concentrate (g) | 2.51 |
| Lactose (g) | 2.896 |
| Medium-Chain triglyceride oil (g) | 2.04 |
| Soy Oil FCC K (g) | 1.53 |
| Sunflower oil - High oleic K (g) | 1.0836 |
| Casein Hydrolysate (g) | 1.52 |
| Calcium Phosphate, Tribasic (mg) | 427.09 |
| Lecithin Concentrate (mg) | 153 |
| Calcium Carbonate (mg) | 127.9 |
| Dry Vitamin Premix (mg) | 124.4 |
| Potassium Chloride (mg) | 97.3 |
| Sodium Citrate Dihydrate (mg) | 66.3 |
| Magnesium Phosphate (mg) | 61.24 |
| Sodium Ascorbate (mg) | 58.44 |
| Mono- and Di-glycerides (mg) | 50 |
| Sodium Chloride (mg) | 45.1 |
| Carrageenan (mg) | 38.43 |
| Choline Chloride (mg) | 27.6 |
| Nucleotide premix (mg) | 12.1 |
| Ferrous sulfate (mg) | 10 |
| A, D, E, K1 (mg) | 9.8 |
| Zinc Sulfate monohydrate FCC (mg) | 4.3 |
| L-Carnitine K (mg) | 2.9 |
| Cupric Sulfate PWD (mg) | 0.4 |

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although preferred embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. For example, while methods for the production of a commercially sterile liquid nutritional supplement made according to those methods have been exemplified, other uses are contemplated. Therefore, the spirit and scope of the appended claims should not be limited to the description of the preferred versions contained therein.

What is claimed is:

1. A preterm infant formula, comprising:
a carbohydrate source;
a fat source; and
a protein source, wherein the protein source comprises whey and hydrolyzed casein.

2. The preterm infant formula of claim 1, wherein the protein source of the nutritional composition comprises a whey:hydrolyzed casein ratio of from about 90:10 to about 50:50 by weight.

3. The preterm infant formula of claim 1, wherein the hydrolyzed casein has a degree of hydrolysis of from about 20% to 80%.

4. The preterm infant formula of claim 1, further comprising a source of iron.

5. The preterm infant formula of claim 1, further comprising vitamins and minerals.

6. The preterm infant formula of claim 1, further comprising at least one long chain polyunsaturated fatty acid.

7. The preterm infant formula of claim 6, wherein the long chain polyunsaturated fatty acid is docosahexaenoic acid.

8. A method for promoting gastric emptying in a target subject, the method comprising administering to the subject a nutritional composition comprising:
a carbohydrate source;
a fat source; and
a protein source comprising intact whey and hydrolyzed casein.

9. The method of claim 8, wherein the protein source of the nutritional composition comprises a whey:hydrolyzed casein ratio of from about 90:10 to about 50:50 by weight.

10. The method of claim 8, wherein the hydrolyzed casein has a degree of hydrolysis of from about 20% to 80%.

11. The method of claim 8, wherein the target subject is a preterm infant.

12. The method of claim 8, wherein the target subject is a very-low-birth-weight infant.

13. The method of claim 8, wherein the nutritional composition further comprises at least one long chain polyunsaturated fatty acid.

14. The method of claim 13, wherein the long chain polyunsaturated acid comprises docosahexaenoic acid.

15. A method for promoting head growth and improving the neurological outcome in a preterm infant, wherein the method comprises administering to the preterm infant a nutritional composition comprising:
a carbohydrate source;
a fat source; and
a protein source comprising intact whey and hydrolyzed casein.

16. The method of claim 15, wherein the protein source comprises a whey:hydrolyzed casein ratio of from about 90:10 to about 50:50 by weight.

17. The method of claim 15, wherein the hydrolyzed casein has a degree of hydrolysis of from about 20% to 80%.

18. The method of 15, wherein the nutritional composition further comprises at least one long chain polyunsaturated fatty acid.

19. The method of claim 18, wherein the nutritional composition further comprises docosahexaenoic acid.

20. The method of claim 15, wherein the preterm infant is a very-low-birth-weight infant.
